(19) United States
(12) Patent Application Publication
(10) Pub. No.: US 2012/0312632 A1
(43) Pub. Date: Dec. 13, 2012

(54) EXTERIOR ACOUSTIC LOUVRE

(76) Inventor: Peter BRAYBROOK, Gloucester (GB)

(21) Appl. No.: 13/486,407

(22) Filed: Jun. 1, 2012

(30) Foreign Application Priority Data
Jun. 7, 2011 (GB) GB1109496.8

(51) Int. Cl. G10K 11/16

(52) U.S. Cl. 181/287

(57) ABSTRACT

An exterior acoustic louvre comprises an internal structural mounting element which is adapted for mounting the louvre to an exterior mounting element, and which has a longitudinal sound-energy baffle extending in a front-to-rear-edge direction of the louvre and at least one lateral sound-energy baffle extending in a top-to-bottom-surface direction of the louvre. At least one sound-energy absorption element overlies at least a majority of the upper and lower surfaces of the longitudinal sound-energy baffle. A sound-attenuating baffle cavity is provided between the upper and lower surfaces of the longitudinal sound-energy baffle, the sound-attenuating baffle cavity extending across at least a majority of a lateral extent of the longitudinal sound-energy baffle. An exterior solar-shading system for a building, comprising a plurality of such exterior acoustic louvres is also provided.

The current application claims a foreign priority to the application in United Kingdom with the serial number GB 1109496.8 filed on Jun. 7, 2011.

### BACKGROUND OF THE INVENTION

The present invention relates to an exterior, preferably solar-shading, acoustic louvre, and more particularly but not necessarily exclusively to such a louvre which is directly or indirectly connectable to a curtain walling mullion on an exterior façade of a building to, amongst other things, provide a pleasing architectural appearance. More preferably, the louvre is directly or indirectly connectable to the building along its rear edge by a bracket having a fastening which is hidden or substantially hidden from view.

Acoustic louvres are well known and are typically mounted horizontally or vertically within fixed perimeter housings. These housings are then located in or around electromechanical units in or on buildings, such as fans and air-conditioners. The acoustic louvres provide noise-deadening whilst also providing ventilation and shielding against ambient environmental conditions, such as sun and rain.

However, these kinds of louvre are connected to their housing via their external cover, which therefore has to be robust and structurally supportive. The exterior shapes of the known acoustic louvres are thus dictated at least in part by the external structural cover elements which must be strong enough to hold the louvre to its fixings. Consequently, known louvres are limited not only by shape but also by the fact that they have to be supported within a surrounding perimeter housing, which itself is unsightly and results in greater material usage.

Furthermore, known acoustic louvres are not designed to be architecturally pleasing. Designers, architects and government bodies are increasingly requiring buildings to have improved aesthetics whilst also having improved operational characteristics.

Additionally, traditional acoustic louvres cannot be optionally utilised for solar-shading on glass façades, frontages and windows due to their support by a surrounding perimeter housing.

Known acoustic louvres are notoriously difficult to clean and maintain, due to their fixing within the external supporting housing.

Finally, known acoustic louvres only utilise a single internal sound-energy baffle which extends from or adjacent to a front edge to or adjacent to the rear edge of the louvre. When sandwiched between sound-energy absorption material, sound attenuation is focused only in the top-to-bottom direction of the louvre, and not in the front-to-rear direction.

The present invention seeks to provide a solution to all of these problems.

### SUMMARY OF THE INVENTION

According to a first aspect of the present invention, there is provided an exterior solar-shading acoustic louvre comprising an internal structural mounting element which is adapted for mounting the louvre to an exterior mounting element and which has a longitudinal sound-energy baffle extending in a front-to-rear-edge direction of the louvre and at least one lateral sound-energy baffle extending in a top-to-bottom-surface direction of the louvre, a sound-energy transmissible cover for covering the internal structural mounting element, upper, lower and front cavities which are defined by the longitudinal and lateral baffles of the internal structural support element and the cover, and a sound-energy absorption element in each of the upper, lower and front cavities.

An exterior acoustic louvre comprises an internal structural mounting element which is adapted for mounting the louvre to an exterior mounting element and which has a longitudinal sound-energy baffle extending in a front-to-rear-edge direction of the louvre and at least one lateral sound-energy baffle extending in a top-to-bottom-surface direction of the louvre, a sound-energy transmissible cover for covering the internal structural mounting element, upper, lower and front cavities which are defined by the longitudinal and lateral baffles of the internal structural support element and the cover, and a sound-energy absorption element in each of the upper, lower and front cavities.

In this case, a lateral extent of each upper and lower sound-energy absorption element may be at least in part curved, so that together the sound-energy absorption elements define at least in part an aerodynamic lateral profile. Furthermore, a lateral extent of the front sound-energy absorption element is preferably substantially triangular.

The upper, lower and front sound-energy absorption elements may each include a watertight casing. Beneficially, the watertight casing is preferably a flexible plastics liquid impermeable casing. The cover may be liquid permeable, and preferably the cover is fabric or perforated metal.

Advantageously, the upper, lower and front sound-energy absorption elements may be formed together on a former, the cover providing a waterproof barrier.

The longitudinal baffle preferably includes an end mount at each end for connecting an end plate and/or a louvre support.

The longitudinal baffle may include a baffle cavity between its upper and lower surfaces. In this case, the said end mounts are preferably within the baffle cavity.

Preferably, at least a majority of the lateral extents of the upper and lower surfaces of the longitudinal baffle is arcuate.

Furthermore, the lateral baffle may comprise two angled walls which extend forwardly from the longitudinal baffle.

The internal structural mounting element preferably further includes a bracket mount at or adjacent to its rear edge. In this case, the bracket mount may include a keyway channel for slidably receiving an exteriorly projecting bracket member.

The exterior acoustic louvre beneficially further comprises cover support members at or adjacent to the rear of the internal structural mounting element. In this case, the cover support members are preferably formed as part of the bracket mount.

The exterior acoustic louvre may also further comprise a cover clamp for clamping the cover to or adjacent to the rear edge of the internal structural mounting element. In this case, a cap which is engagable with the cover clamp may be included for forming a rear edge of the louvre. The cap covers at least a majority of the bracket mount along a longitudinal extent of the internal structural mounting element. Additionally or alternatively, the cap is snap-fittably engagable with the cover clamp. Furthermore, the cover may be removable.

In an alternative arrangement, an exterior acoustic louvre may comprise an internal structural mounting element which is adapted for mounting the louvre to an exterior mounting element, and a sound-energy transmissible cover for covering the internal structural mounting element, the cover being fabric.

Furthermore, an exterior solar-shading system for a building is provided which comprises a plurality of exterior acoustic louvres in accordance with any of the preceding aspects.

The invention will now be more particularly described, by way of example only, with reference to the accompanying drawings.

### BRIEF DESCRIPTION OF THE DRAWINGS

FIG. 1 shows a first embodiment of an exterior solar-shading acoustic louvre, in lateral cross-section and in accordance with the invention;

FIG. 2 shows an internal structural mounting element of the exterior acoustic louvre of FIG. 1;

FIG. 3 shows a sound-energy transmissible cover of the exterior acoustic louvre;

FIG. 4 shows a second embodiment of an exterior acoustic louvre, in lateral cross-section and in accordance with the invention;

FIG. 5 shows an internal structural mounting element of the exterior acoustic louvre of FIG. 4;

FIG. 6 shows a sound-energy transmissible cover of the exterior acoustic louvre, sound-energy absorption element, and former;

FIG. 7a shows a third embodiment of an exterior solar-shading acoustic louvre, in lateral cross-section and in accordance with the invention;

FIG. 7b shows a performance graph of sound attenuation against frequency when comparing the louvre of the third embodiment of the invention with a more traditional louvre having internal Rockwool insulation surrounded by a rigid elliptical cover;

FIG. 8 shows a fourth embodiment of an exterior solar-shading acoustic louvre, in lateral cross-section and in accordance with the invention; and

FIG. 9 shows a fifth embodiment of an exterior solar-shading acoustic louvre, in lateral cross-section and in accordance with the invention.

### DESCRIPTION OF THE PREFERRED EMBODIMENTS

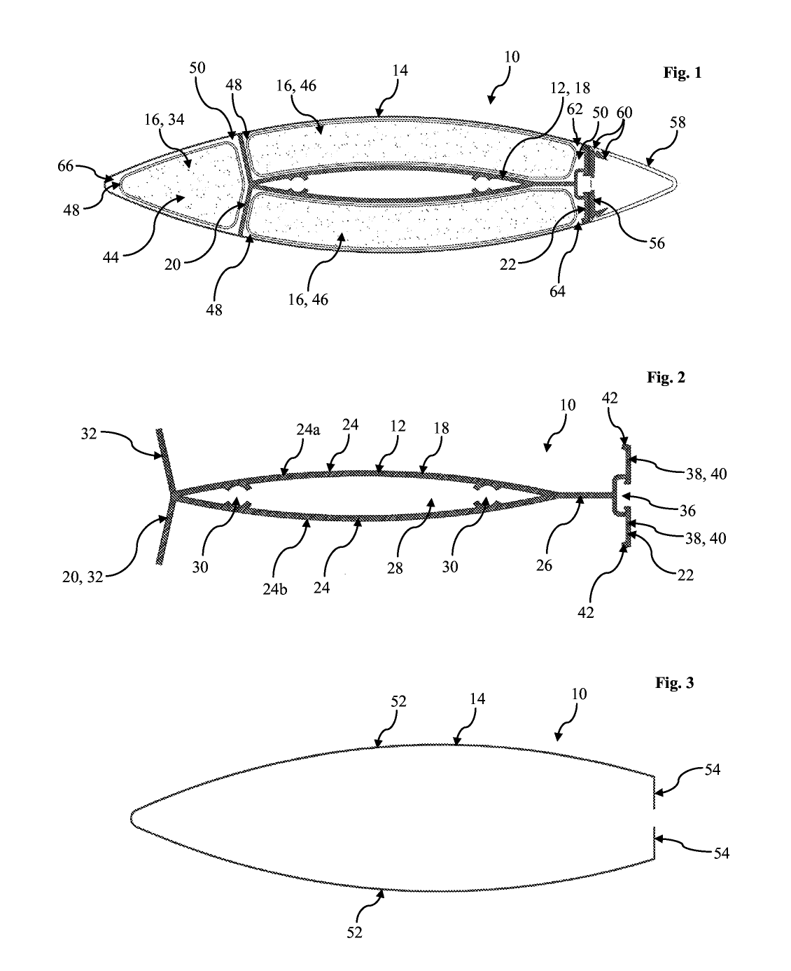

Referring firstly to FIGS. 1 to 3 of the drawings, there is shown a first embodiment of an exterior acoustic louvre 10 which comprises a rigid, preferably metal, internal structural mounting element 12, a sound-energy transmissible cover 14, and a plurality of sound-energy absorption elements 16, such as acoustic foam, supported by the internal structural mounting element 12 and covered by the sound-energy transmissible cover 14.

In a lateral cross-sectional direction, the internal structural mounting element 12 includes a longitudinal sound-energy baffle 18 which extends in a front-to-rear edge direction of the louvre 10, a front lateral sound-energy baffle 20 which extends in a top-to-bottom-surface direction of the louvre 10, and a bracket mount 22 at or adjacent to the rear edge of the louvre 10 which also functions as a rear lateral sound-energy baffle 20.

The longitudinal sound-energy baffle 18 is preferably at least in part laterally curved, and in this embodiment comprises two plates 24, defining upper and lower surfaces 24a, 24b respectively, and each having an arcuate lateral extent and a straight longitudinal extent. The two plates 24 are curved in opposite directions such that they meet and join at their front and rear longitudinal edges. A planar tail plate 26 extends from the rear edge join of the curved plates 24 to the bracket mount 22.

The curved plates 24 define a baffle cavity 28 therebetween, wherein the sound-attenuating baffle cavity 28 extends across at least a majority of a lateral extent of the longitudinal sound-energy baffle 20. The baffle cavity 28 may simply hold air, or it may include a further sound-energy absorption element, such as the aforementioned acoustic foam.

To provide the option of end mounting the louvre 10 and/or attaching an end closure element, such as an end plate, the longitudinal sound-energy baffle 18 includes an end mount 30 at each lateral end. The end mount 30 in this case is a plurality of spaced-apart screw-ports within the baffle cavity 28. However, the screw-ports may be supplemented or replaced by locating pins or any other suitable connector.

The front lateral sound-energy baffle 20 includes two walls 32 which extend in substantially opposite directions from the front edge of the longitudinal sound-energy baffle 18. Preferably, the walls 32 are continuously and uniformly solid to act as a sound barrier and reflector. Both walls 32 extend at a slight angle forwardly of the longitudinal sound-energy baffle 18. This is beneficial in directing incident sound energy back into the densest part of the sound-energy absorption element 16 at the nose 34 of the louvre 10.

However, the walls 32 may be in the same plane, and this plane may be perpendicular or non-perpendicular relative to the plane of the longitudinal sound-energy baffle 18. It may be beneficial to provide the lateral sound-energy baffle 20 with angular adjustment so that, during manufacture and/or installation, the sound attenuating properties of the louvre 10 can be tuned dependent on the environment, location and design of the building.

The bracket mount 22 is provided at the free distal edge of the tail plate 26, and includes a keyway channel 36. Conveniently, cover support members 38, in this case longitudinal walls 40 which extend the length of the louvre 10, extend outwardly from the longitudinal rear edges of the keyway channel 36, preferably being substantially perpendicular to the plane of the tail plate 26. Distal ends 42 of the cover support members 38 are hooked or turned over to provide an increased mounting surface-area for the cover 14.

As with the front lateral sound-energy baffle 20, it is preferable that the walls 40 of the bracket mount 22 are solid and uniformly continuous to improve sound attenuation and increase the structural rigidity of the louvre 10.

The keyway channel 36 of the bracket mount 22 is preferably rectilinear and preferably extends the length of the louvre 10. An exteriorly-projecting bracket, which is not shown, having a suitable key-type head can then be slidably engaged with the keyway channel 36 and suitably positioned therealong as necessity dictates. A fastening, preferably one to each side of the bracket body, may then be utilised to fix the key-type head of the exteriorly-projecting bracket in place along the channel 36.

An alternative to the keyway channel 36 is simply to utilise the said fastening to connect the head of the exteriorly-projecting bracket to the bracket mount 22. However, this is not as strong and as such may not be as preferable as using the keyway channel 36.

In this invention, a plurality of preformed said sound-energy absorption elements 16 is provided. Each sound-energy absorption element 16 is profiled from acoustic foam or similar acoustic attenuating material to match part of the required shape of the louvre 10. In this case, a substantially triangular nose sound-energy absorption element 44 is provided for location to the front of the lateral sound-energy baffle 20, and two body sound-energy absorption elements 46 are provided for mounting on the upper and lower surfaces 24a, 24b of the longitudinal sound-energy baffle 18 so as to overlie at least a majority thereof. The body sound-energy absorption elements 46 are laterally curved to part form the aerodynamic lateral profile of the louvre 10.

Each sound-energy absorption element 16 may be separately encased by a watertight membrane or casing 48, preferably during manufacture. In this embodiment, the watertight casing 48 is a pliantly-flexible plastics liquid-impermeable acoustic-permeable casing. Preferably, the casing 48 is air-permeable to better permit the passage into the sound-energy absorption element 16 of noise to be attenuated or damped.

It is thus relatively straightforward to specify specific profiles and/or dimensions of the sound-energy absorption elements 16, and to alter the cover 14 to meet different architectural and/or performance requirements.

Although the sound-energy absorption elements 16 are beneficially relatively rigid, it may be possible to use more fibrous, flexible and/or loose-packed acoustically insulating material, such as Rockwool®. In this case, it would still be necessary to provide a waterproof barrier to prevent precipitation being absorbed and held by the sound-energy absorption elements, thereby significantly reducing their effectiveness.

With the sound-energy absorption elements 16 mounted on the internal structural mounting element 12, the cover 14 is placed therearound to preferably at least in part hold the sound-energy absorption elements 16 in place. There may therefore be a slight air gap 50 between the cover 14 and/or the internal structural mounting element 12 and the sound-energy absorption elements 16.

The front lateral sound-energy baffle 20 beneficially supports the cover 14 adjacent to the front edge of the louvre 10, and the bracket mount 22 beneficially supports the cover 14 adjacent to the rear edge of the louvre 10. However, if the cover 14 is suitably rigid, for example, if formed of metal or rigid plastics, then such direct internal support for the cover 14 may not be required.

The cover 14 is preferably liquid permeable but sound-energy transmissible. To this end, the cover 14 may be metal or rigid plastics having perforations through both the upper and lower walls 52 to allow the passage of sound-energy.

As an alternative, the cover 14 may be fabric. Such fabric may be woven or non-woven, and natural or synthetic. Combinations thereof are also feasible. Such a fabric cover 14 may be liquid permeable, but it may alternatively provide a waterproof barrier whilst still allowing the passage of sound-energy.

Rear edge portions 54 of the cover 14 are hooked to lie against the cover support members 38 of the bracket mount 22. A cover clamp 56 is then provided for clamping the rear edge portions 54 of the cover 14 to the cover support members 38. The cover clamp 56 is, for example, an elongate plate or strip which may be screw-threadingly fastened, riveted and/or welded to the cover support members 38. Preferably, the cover clamp 56 is disengagable.

To enable the head of the exteriorly-projecting bracket and thus also the fastenings to be hidden or substantially hidden from view, the louvre 10 preferably includes a cap 58 on its rear edge. The cap 58 is preferably extruded plastics or metal. The cap 58 may have any suitable lateral cross-sectional shape, and in this case is substantially triangular to mirror the louvre nose 34 and to finish the lateral aerodynamic profile.

Conveniently, the cap 58 is engagable with the cover clamp 56, and in this case the cap 58 is beneficially snap-fittable thereto via interlockable edge tangs 60. Sectional lengths of the cap 58 extend up to the sides of the body of the exteriorly-projecting bracket member, once attached to the keyway channel 36, and preferably abut thereto. In this way, the bracket member projects rearwardly from within the louvre 10, providing a smooth and almost seamless interface to a mounting surface, such as a curtain wall mullion, exterior building facade, wall or other support.

Preferably, the cap 58 is removable thereby allowing the cover 14 to be removed once the cover clamp 56 is disengaged. This is useful for maintenance, repair and cleaning.

In use, the profiles of the upper, lower and front or nose sound-energy absorption elements 16 are formed as required. Upper, lower and front cavities 62, 64, 66 are defined in the louvre 10 by the internal structural mounting element 12 and the sound-energy transmissible cover 14. The respective sound-energy absorption elements 16 are located in the upper, lower and front cavities 62, 64, 66. The cover 14 is secured in place around the separate sound-energy absorption elements 16 by the cover clamp 56 clamping the rear edge portions 54 of the cover 14 to the cover support members 38 of the bracket mount 22. With one or more bracket members extending rearwardly from the keyway channel 36, cut-to-length sections of the cap 58 are connected to the cover clamp 56 to hide the bracket member head and fastenings.

If a rearwardly projecting bracket is not to be used, then a single cap 58 can extend the entire longitudinal extent of the rear edge of the louvre 10. In this case, the end mounts 30 at the lateral side ends of the internal structural mounting element 12 can be utilised to secure the louvre 10 to side mounting brackets.

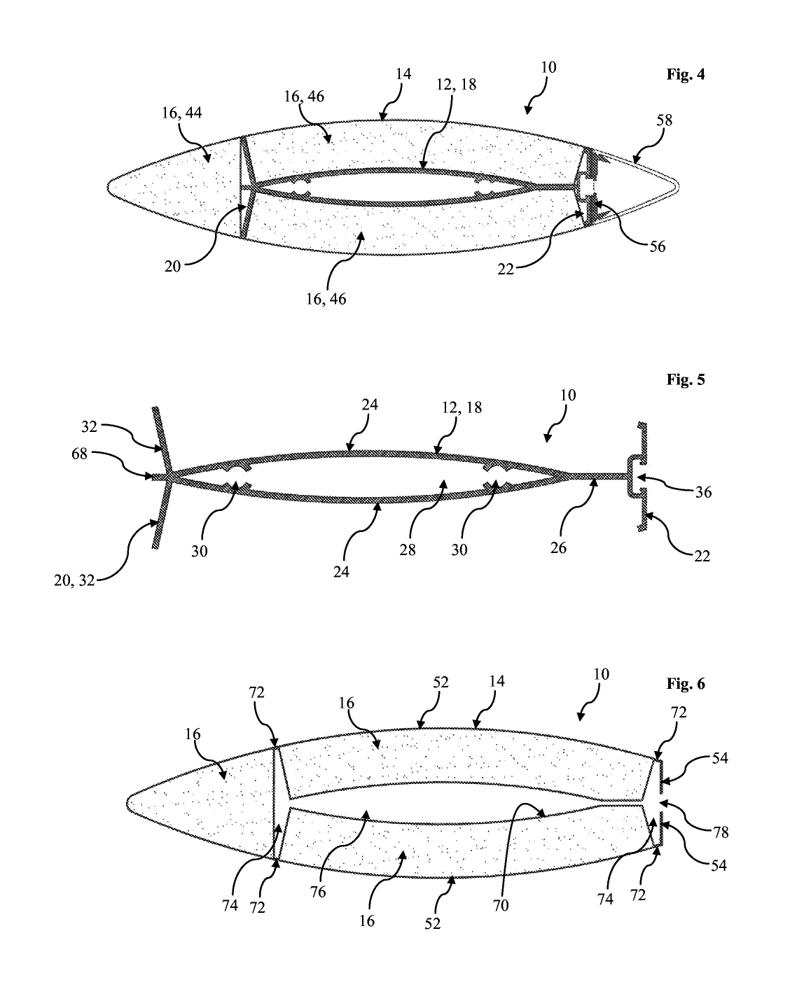

Referring now to FIGS. 4 to 6, a second embodiment of an exterior acoustic louvre is shown. Similar references refer to parts which are described in the first embodiment, and therefore further detailed description is omitted.

The exterior acoustic louvre 10 of this embodiment again comprises a rigid, preferably metal or plastics, internal structural mounting element 12, a sound-energy transmissible cover 14, and a plurality of sound-energy absorption elements 16, such as acoustic foam, supported by the internal structural mounting element 12 and covered by the sound-energy transmissible cover 14.

In this case, the internal structural mounting element 12 is substantially the same as that of the first embodiment, except for the addition of a forwardly projecting additional nose element 68. This acts as a brace as well as an additional sound-energy baffle.

An internal former 70, typically of a thin metal or plastics, together with the cover 14 are used to form upper, lower and front cavities 62, 64, 66 for the sound-energy absorption elements 16. The internal former 70 and cover 14 are interconnected, for example, by spot welding, abutting points 72, such that the cover 14 again preferably forms an aerodynamic lateral profile. The abutting points 72 conveniently coincide with the distal ends of lateral cavities 74 formed by the former 70 to receive the lateral sound-energy baffle 20 and the bracket mount 22. A longitudinal cavity 76 is provided by the former 70 to receive the longitudinal sound-energy baffle 18.

The internal structural mounting element 12 is thus then received in the former 70, for example, by sliding from one end, or by insertion in a lateral direction through the longitudinal rear edge 78. In this latter case, the former 70, cover 14 and sound-energy absorption elements 16 are simply deformed or pulled apart to allow the internal structural mounting element 12 to be inserted, and then closed back therearound.

A bracket member is engaged with the keyway channel 36, if required, the cover clamp 56 is attached, as in the first embodiment, and the rear cap 58 is applied.

In this second embodiment, the sound-energy absorption elements 16 may not need to be separately encased in a waterproof material. In this case the cover 14 provides a waterproof barrier, and the sound energy absorption elements are sealed in their respective cavities formed between the cover 14 and the former 70.

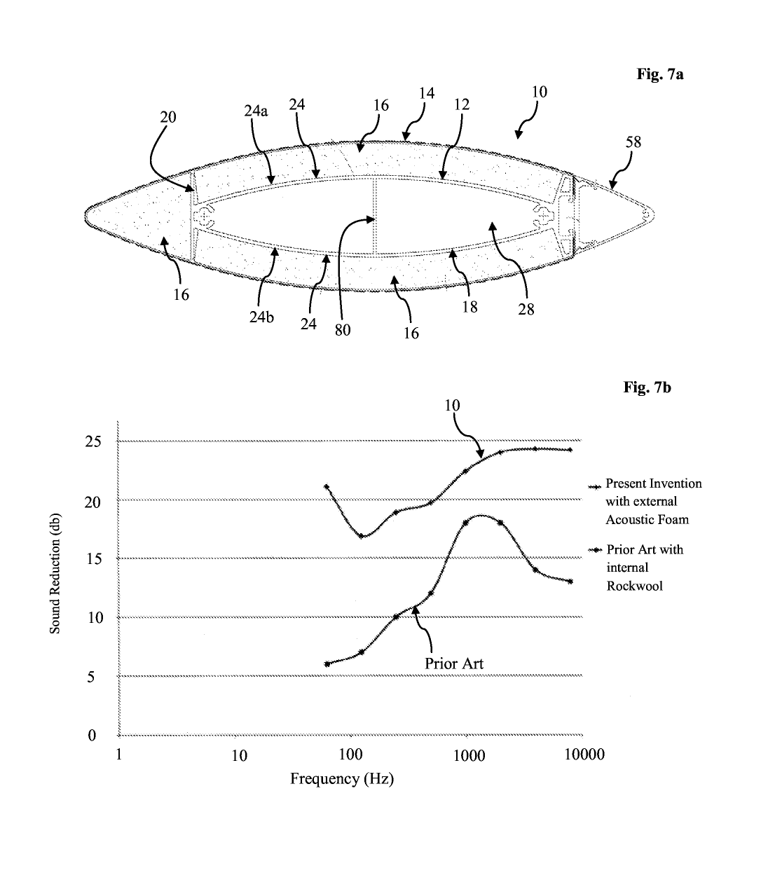

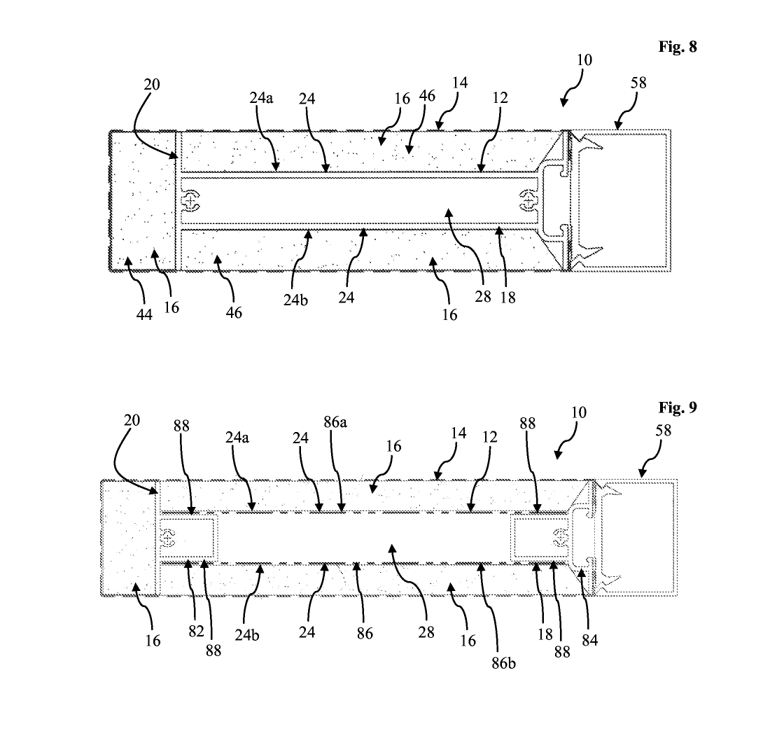

Referring now to FIG. 7a, a third embodiment of an exterior acoustic louvre is shown. Similar references again refer to parts which are described in the first embodiment, and therefore further detailed description is omitted.

The exterior acoustic louvre 10 of this embodiment again comprises a rigid, preferably metal or plastics, internal structural mounting element 12, a sound-energy transmissible cover 14, and a plurality of sound-energy absorption elements 16, such as acoustic foam, supported by the internal structural mounting element 12 and covered by the sound-energy transmissible cover 14.

In this case, the internal structural mounting element 12 is substantially the same as that of the first embodiment, except that the front lateral sound-energy baffle 20 is a uniformly planar or substantially planar solid or unperforated plate.

Furthermore, the tail plate 26 is dispensed with, whereby the two arcuate plates 24 of the longitudinal sound-energy baffle 18 meet at the bracket mount 22.

A partitioning element 80 may be provided partway along the lateral extent of the baffle cavity 28. The partitioning element 80 extends vertically between the upper and lower plates 24, and longitudinally along the mounting element 12. The partitioning element 80 functions not only as a structural brace, but also enables tuning of the baffle cavity 28 dependent on ambient environmental conditions at the installation site. For example, the thickness of the partitioning element 80 can be adjusted during manufacture and/or apertures can be included.

As can be seen by FIG. 7b, the graph shows sound attenuation in terms of a reduction in decibels at various frequencies when comparing the louvre 10 of the third embodiment with a traditional louvre having internal Rockwool insulation surrounded by a rigid elliptical cover. The sound reduction is dramatic and is put down to not only the sound-energy absorption elements 16 being external of the structural mounting element 12 rather than internal, but also of the large longitudinal sound-attenuating baffle cavity 28 extending across at least a majority of a lateral extent of the longitudinal sound-energy baffle 18.

Referring now to FIG. 8, a fourth embodiment of an exterior acoustic louvre is shown. Similar references again refer to parts which are described in the first embodiment, and therefore further detailed description is omitted.

The exterior acoustic louvre 10 of this embodiment is similar in many respects to that of the third embodiment, except that a lateral extent of the longitudinal sound-energy baffle 18 is linear, in this case being rectangular, instead of arcuate or elliptical. The louvre 10 comprises a rigid, preferably metal or plastics, internal structural mounting element 12, a sound-energy transmissible cover 14, and a plurality of sound-energy absorption elements 16, such as acoustic foam, supported by the internal structural mounting element 12 and covered by the sound-energy transmissible cover 14.

Due to the upper and lower plates 24 being flat or planar in this embodiment, the baffle cavity 28 has a rectangular or substantially rectangular lateral cross-section which is uniform or substantially uniform along at least a majority of its longitudinal extent.

The nose sound-energy absorption element 44 is preferably rectangular or square, and the body sound-energy absorption elements 46 are substantially planar, instead of being curved laterally. The cap 58 on the rear edge is also preferably rectangular or square in lateral cross-section.

Referring now to FIG. 9, a fifth embodiment of an exterior acoustic louvre is shown. Similar references again refer to parts which are described in the first embodiment, and therefore further detailed description is omitted. As with the previous embodiment, a lateral extent of the longitudinal sound-energy baffle 18 is linear, in this case being rectangular, instead of arcuate or elliptical. The louvre 10 comprises a rigid or substantially rigid, preferably metal or plastics, internal structural mounting element 12, a sound-energy transmissible cover 14, and a plurality of sound-energy absorption elements 16, such as acoustic foam, supported by the internal structural mounting element 12 and covered by the sound-energy transmissible cover 14.

The exterior acoustic louvre 10 of this embodiment is similar in many respects to that of the fourth embodiment, except that a lateral extent of the longitudinal sound-energy baffle 18 is adjustable. In this way, a volume of the sound-attenuating baffle cavity 28 is settable based on an adjustment of the lateral extent of the longitudinal sound-energy baffle 18.

To achieve this adjustability, the internal structural mounting element 12 includes separate front and rear parts 82 and 84 interconnectable by at least one bridge member 86. In this embodiment, upper and lower bridge members 86a and 86b are provided, preferably being formed from perforated metal or plastics plate. A lateral extent of the bridge members 86a, 86b can thus be cut to a required dimension.

By fastening the bridge members 86a, 86b to upper and lower lands 88 of the front and rear parts 82, 84, for example, by welding, bonding or via fasteners such as rivets, the longitudinal sound-energy baffle 18 is formed with the volume-adjustable baffle cavity 28.

Although in this embodiment, the lateral extent of the longitudinal baffle cavity 28 is substantially rectangular, by utilising bridge members with arcuate lateral extents, a substantially elliptical baffle cavity 28 can be formed, similarly to the first to third embodiments.

The arrangement of the fifth embodiment is advantageous, since it allows acoustic tuning of especially the longitudinal baffle cavity 28 and sound-energy absorption elements 16. By adjusting the respective volumes, materials and perforations, noise attenuation can be optimised for a specific installation site. For example, the bridge members may both be perforated, but equally, one may be solid whilst the other is perforated, or both may be solid, all depending on requirements.

Although a cover is described for the embodiments above, this may be dispensed with. For example, the or each sound-energy absorption element may include a waterproof or water-resistant coating, thereby making the cover unnecessary. To hold the sound-energy absorption element to the internal structural mounting element, a suitable exterior adhesive could be utilised.

The louvre should be air permeable and preferably not liquid permeable. As such, the louvre is preferably water proof when exposed to ambient conditions external to a building or other installation site. This is in order to keep the sound attenuating material, preferably being acoustic foam, dry.

A louvre which is air permeable with a perforated cover to provide a suitable aesthetic appearance is preferred. The cover is actually detrimental to sound absorption, since both the membrane and the cover reduce noise attenuation effectiveness at various frequencies. However, the cover and/or membrane may be essential requirements for example to achieve suitable weatherability and appearance. The membrane prevents the acoustic foam being saturated with water which may affect sound attenuation properties, plus it also protects against degradation of the acoustic foam from ultraviolet radiation when exposed to the exterior of a building or other installation site. The cover and/or membrane are also beneficial in holding the foam profile in shape.

If the louvre is used behind a weather screen, a cover could be a ‘netting’, a wire or plastic mesh. The mesh is only required to hold the foam profile together. Because the blade is hidden, the aesthetics and risk of water penetration is eradicated or reduced. The louvre would still be classed as an exterior louvre as it is used in an exterior wall or screen.

Additionally, the front cavity or only the front sound-energy absorption element could be dispensed with, thereby relying primarily on the lateral sound-energy baffle to initially attenuate edge on noise.

Although a plurality of sound-energy absorption elements are suggested, it may be feasible to form these elements as a single sound-energy absorption element.

The longitudinal sound-energy baffle may be a single element or plate instead of two curved plates jointed at their longitudinal edges.

If a rearwardly extending bracket is not to be used, then the keyway channel may be dispensed with and thus the bracket mount may only be a rear baffle and/or cover support. Similarly, if the end mount is not required, then this may be dispensed with.

Although the exterior acoustic louvre is preferably for use in an exterior solar-shading system of a building, it could be utilised on a ventilation unit or any other structure requiring louvre coverage with sound attenuation.

The air pockets provided within the louvre enhance the performance of the acoustics attenuation, and in particular the longitudinal baffle cavity is seen as being essential. The centralized air pocket in the longitudinal sound-energy baffle also helps to shape the blade and provides greater structural rigidity. As such, the longitudinal sound-attenuating baffle cavity extends across at least a majority of a lateral extent of the longitudinal sound-energy baffle. This provides the louvre with maximum tunability to meet different installation locations and requirements.

It is thus possible to provide an exterior acoustic louvre which provides a greater degree of sound attenuation due to the use of both longitudinal and lateral baffles, as well as profiled upper, lower and front or nose sound-energy absorption material. The louvre can be profiled as required by forming the sound-energy absorption elements to the profile instead of the supporting structure, which until now has always been external of the sound-energy absorption elements or material. The sound-energy absorption elements may form the profile of the cover, which can thus be light and even formed of fabric, such as canvas. The cover may provide a waterproof barrier, but in any event is as sound-energy transparent as possible. It is also possible to provide a louvre with an internal structural mounting element which is adapted for mounting the louvre to an exterior mounting element, such as a curtain walling mullion, exterior façade, ventilation housing, and/or across glass. The exterior cover may thus not be a structural supporting component, and may even be dispensed with. By providing the internal structural mounting element which supports a rearwardly projecting exterior mounting bracket, a bracket head and fastenings can beneficially be hidden from view by the use of a cap on the rear longitudinal edge of the louvre. Due to the standalone nature of the louvre, since it is supportable by side or rear edge brackets, it also becomes aesthetically suitable for use as exterior solar shading on a building, which consequently also benefits the building in terms of noise reduction. The large interior baffle cavity or cavities provide for a different medium for noise to pass through. The present invention advantageously provides three different mediums: the sound-energy absorption elements, the rigid internal structural mounting element, and the baffle cavity. These different mediums all allow tuning of the louvre to best attenuate sound at a given installation site.

The embodiments described above are provided by way of examples only, and various other modifications will be apparent to persons skilled in the art without departing from the scope of the invention as defined by the appended claims.

What is claimed is:

1. An exterior acoustic louvre comprising an internal structural mounting element which is adapted to mount the louvre to an exterior mounting element and which has a longitudinal sound-energy baffle extending in a front-to-rear-edge direction of the louvre and at least one lateral sound-energy baffle extending in a top-to-bottom-surface direction of the louvre, at least one sound-energy absorption element overlying at least a majority of the upper and lower surfaces of the longitudinal sound-energy baffle, and a sound-attenuating baffle cavity between upper and lower surfaces of the longitudinal sound-energy baffle, the sound-attenuating baffle cavity extending across at least a majority of a lateral extent of the longitudinal sound-energy baffle.

2. An exterior acoustic louvre as claimed in claim 1, wherein a lateral extent of the longitudinal sound-energy baffle is adjustable.

3. An exterior acoustic louvre as claimed in claim 2, wherein a volume of the sound-attenuating baffle cavity is settable based on an adjustment of the lateral extent of the longitudinal sound-energy baffle.

4. An exterior acoustic louvre as claimed in claim 2, wherein the internal structural mounting element includes separate front and rear parts interconnectable by at least one bridge member, a lateral extent of the said bridge member being adjustable.

5. An exterior acoustic louvre as claimed in claim 4, wherein upper and lower said bridge members are provided, the said sound-attenuating baffle cavity being defined by the front and rear parts and the upper and lower bridge members.

6. An exterior acoustic louvre as claimed in claim 1, further comprising a sound-energy transmissible cover which covers the internal structural mounting element, the sound-energy transmissible cover and the longitudinal and lateral baffles of the internal structural support element defining upper, lower and front cavities.

7. An exterior acoustic louvre as claimed in claim 6, wherein the cover is liquid permeable and at least one of fabric and perforated metal.

8. An exterior acoustic louvre as claimed in claim 6, wherein the said at least one sound-energy absorption element is provided in the upper and lower cavities, and a further sound-energy absorption element is provided in the front cavity.

9. An exterior acoustic louvre as claimed in claim 1, wherein the sound-attenuating baffle cavity has one of a substantially elliptical lateral extent and a rectangular lateral extent.

10. An exterior acoustic louvre as claimed in claim 1, wherein the or each said sound-energy absorption element includes a watertight casing.

11. An exterior acoustic louvre as claimed in claim 1, wherein the internal structural mounting element further includes a bracket mount at or adjacent to its rear edge, the bracket mount including a keyway channel for slidably receiving an exteriorly projecting bracket member.

12. An exterior acoustic louvre as claimed in claim 1, further comprising a cover clamp which clamps the cover to or adjacent to the rear edge of the internal structural mounting element.

13. An exterior acoustic louvre as claimed in claim 12 when dependent on claim 11, further comprising a cap which is engagable with the cover clamp to form a rear edge of the louvre, the cap covering at least a majority of the bracket mount along a longitudinal extent of the internal structural mounting element.

14. An exterior acoustic louvre as claimed in claim 1, further comprising cover support members at or adjacent to the rear of the internal structural mounting element.

15. An exterior solar-shading system for the outside of a building, the system comprising a plurality of exterior acoustic louvres, each exterior acoustic louvre comprising an internal structural mounting element which is adapted to mount the louvre to an exterior mounting element and which has a longitudinal sound-energy baffle extending in a front-to-rear-edge direction of the louvre and at least one lateral sound-energy baffle extending in a top-to-bottom-surface direction of the louvre, at least one sound-energy absorption element overlying at least a majority of the upper and lower surfaces of the longitudinal sound-energy baffle, and a sound-attenuating baffle cavity between upper and lower surfaces of the longitudinal sound-energy baffle, the sound-attenuating baffle cavity extending across at least a majority of a lateral extent of the longitudinal sound-energy baffle.
